(19) United States
(12) Patent Application Publication
(10) Pub. No.: US 2010/0277027 A1
(43) Pub. Date: Nov. 4, 2010

(54) SKEW PATTERN FOR A PERMANENT MAGNET ROTOR

(75) Inventors: Edward L. Kaiser, Orion, MI (US); Khwaja M. Rahman, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/626,974

(22) Filed: Nov. 30, 2009

Related U.S. Application Data
(60) Provisional application No. 61/174,218, filed on Apr. 30, 2009.

(51) Int. Cl. H02K 21/14

(52) U.S. Cl. 310/156.47

(57) ABSTRACT

A rotor for an electric machine includes a plurality of magnet stacks having at least five permanent magnets formed into a skew pattern within each of the magnet stacks. The skew pattern has a skew angle and at least two skew steps, and is an angle of rotation about the axis between individual magnets adjacent to the skew steps. The skew pattern may be an axially-symmetric V-shape. The plurality of magnet stacks may have five, six, or eight permanent magnets therein. The number of skew steps may be equal to two or three. The skew angle may be calculated as 360 degrees, divided by the number of skew steps plus one, multiplied by the least common multiple of the number of rotor poles and the number of the plurality of stator slots.

### CROSS-REFERENCE TO RELATED APPLICATIONS

This application claims the benefit of U.S. Provisional Application No. 61/174,218, filed Apr. 30, 2009, which is hereby incorporated by reference in its entirety.

### TECHNICAL FIELD

This disclosure relates to permanent magnet rotors for electrical machines.

### BACKGROUND OF THE INVENTION

An electric motor uses electrical energy to produce mechanical energy through the interaction of magnetic fields and current-carrying conductors. The reverse process, using mechanical energy to produce electrical energy, is accomplished by a generator or dynamo. Traction motors used on hybrid vehicles often perform both tasks. Other electric machines combine various features of both motors and generators.

Electric machines may include an element rotatable about a central axis. The rotatable element, which may be referred to as a rotor, may be coaxial with a static element, which may be referred to as a stator. The electric machine uses relative rotation between the rotor and stator to produce mechanical energy or electric energy.

### SUMMARY

A rotor for an electric machine includes a plurality of magnet stacks, each having at least five permanent magnets therein. The magnet stacks are arranged annularly about an axis of the rotor. The permanent magnets are formed into a skew pattern within each of the magnet stacks, and the skew pattern is defined by a skew angle and at least two skew steps. The skew angle is an angle of rotation about the rotor axis between individual permanent magnets adjacent to each of the skew steps.

The skew pattern may be symmetric along the rotor axis and may be an axially-symmetric V-shape. The skew angle is inversely related to the number of skew steps. Each of the plurality of magnet stacks may have five, six, or eight permanent magnets therein. The number of skew steps may be equal to two skew steps or three skew steps.

Each of the plurality of magnet stacks may define one pole of the rotor, such that the number of rotor poles equals the number of magnet stacks. The rotor is configured to operate in conjunction with a stator having a plurality of stator slots. The skew angle may be calculated as 360 degrees divided by the number of skew steps plus one, multiplied by the least common multiple of the number of rotor poles and the number of the plurality of stator slots.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic, partial isometric view of a rotor and a stator for an electric machine;

FIG. 2 is a close up view of a portion of the schematic rotor shown in FIG. 1;

FIG. 3 is a schematic, linear approximation of a skew pattern which may be implemented for a rotor similar to that shown in FIG. 1, having two skew steps and five permanent magnets; and

FIG. 4 is a schematic, linear approximation of a skew pattern which may be implemented for a rotor similar to that shown in FIG. 1, having three skew steps and eight permanent magnets.

### DESCRIPTION OF PREFERRED EMBODIMENTS

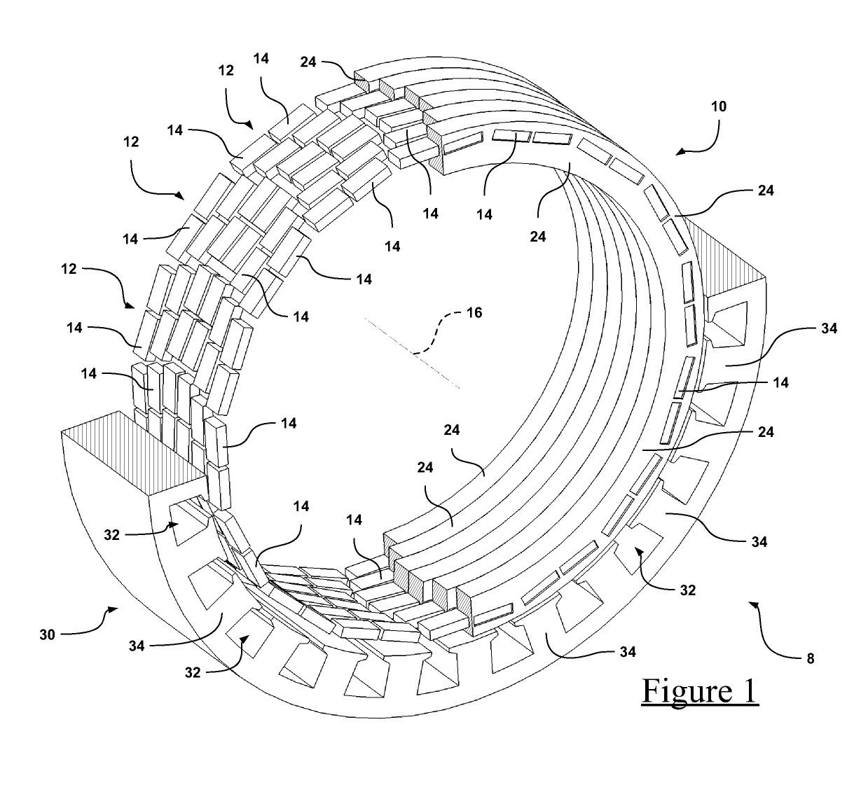

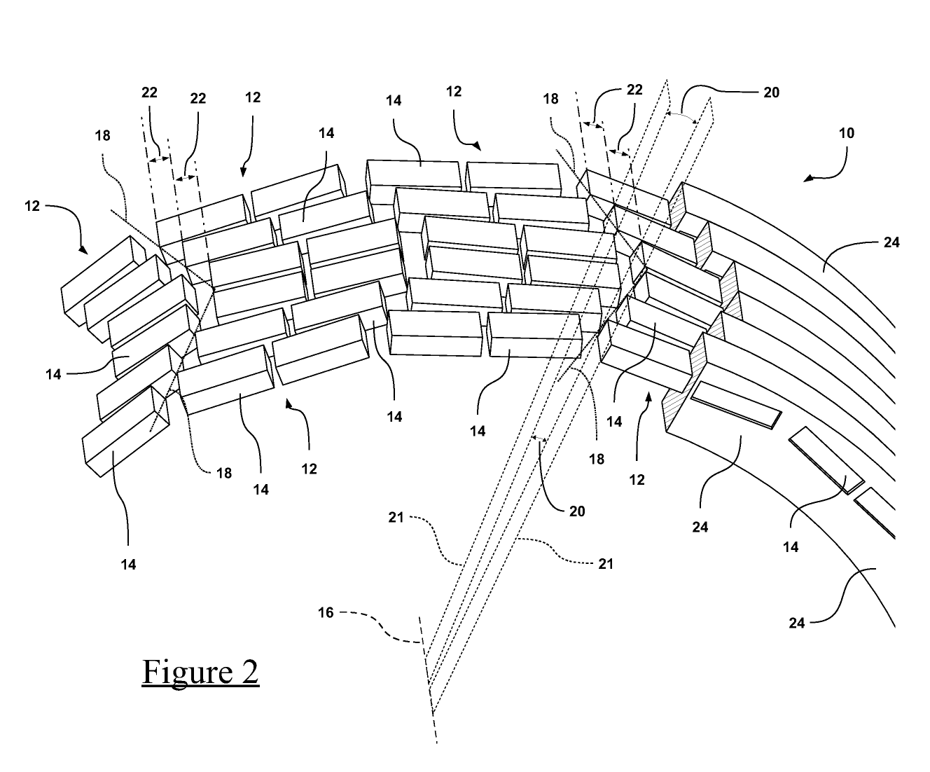

Referring to the drawings, wherein like reference numbers correspond to like or similar components throughout the several figures, there is shown in FIG. 1 an electric machine 8 having a rotor 10 and a stator 30. For illustrative purposes, both the rotor 10 and stator 30 are only partially shown in FIG. 1. Depending on the machine control and drive electronics, the electric machine 8 may be an electric motor, a generator, a combined electric motor/generator, or another electric machine recognizable to those having ordinary skill in the art. FIG. 2 shows a close up or zoomed view of a portion of the rotor 10 shown in FIG. 1.

Those having ordinary skill in the art will recognize that terms such as “above,” “below,” “upward,” “downward,” et cetera, are used descriptively of the figures, and do not represent limitations on the scope of the invention, as defined by the appended claims.

Referring now to FIGS. 1 and 2, the rotor 10 includes a plurality of magnet stacks 12, each of which are formed from at least five permanent magnets 14. In the configuration shown in FIGS. 1 and 2, each of the magnet stacks 12 includes twelve permanent magnets 14. The twelve permanent magnets 14 are arranged as pairs in six rows. A similar effect (and pattern, as discussed further herein) may be achieved with six permanent magnets 14. The magnet stacks 12 are arranged annularly about an axis 16. The electric machine 8 functions through relative rotation between the rotor 10 and stator 30 about the axis 16, as would be recognized by one having ordinary skill in the art.

The permanent magnets 14 are arranged within each of the plurality of magnet stacks 12 to form a skew pattern, referenced generally at 18. In the configuration shown in FIGS. 1 and 2, the skew pattern 18 is generally a V-shape. The skew pattern 18 is defined by a skew angle 20 and at least two skew steps 22. The skew angle 20 is an angle of rotation about the axis 16 between permanent magnets 14 which are adjacent to each of the skew steps 22.

The skew steps 22 are offsets between individual permanent magnets 14 or, as shown in FIGS. 1 and 2, pairs of permanent magnets 14, within the magnet stacks 12. The skew angle 20 is shown schematically in FIG. 2 as an angle of rotation about the axis 16 between two reference planes 21 intersecting two adjacent permanent magnets 14 and the axis 16.

In the configuration shown, the skew angle 20 is substantially constant for each of the skew steps 22, and therefore forms the V-shape, as opposed to a parabolic, or U-shaped, skew pattern. The skew angles 20, however, may vary from each other by a variance factor, δ, due to manufacturing and assembly tolerances or due to designed variance. The number of skew steps 20 may be denoted as N_{skew}, such that: N_{skew}=2.

Furthermore, as shown in FIGS. 1 and 2, the skew pattern 18 is symmetric along the axis 16, such that the permanent magnets 14 on one side of the magnet stack 12 substantially mirror the permanent magnets 14 on the other side of magnet stack 12. The symmetric skew pattern 18 reduces the likelihood of the rotor 10 generating axial forces relative to the stator 30.

The permanent magnets 14 are housed in lamination stacks 24, which are stacked axially and form the divisions in the magnet stacks 12. The lamination stacks 24 may be formed from steel or another material known to those having ordinary skill in the art as configured to securely hold the permanent magnets 14. Note that only a portion of the lamination stacks 24 of the rotor 10 are shown in FIGS. 1 and 2 (approximately half of each lamination stack 24 is shown in FIG. 1). However, the six axial lamination stacks 24 are actually continuous about the rotor axis 16, and each holds and supports two permanent magnets 14 of each of the magnet stacks 12.

During manufacturing and assembly of the rotor 10, each of the axial lamination stacks 24 may be assembled with its permanent magnets 14 separately, and the rotor 10 assembled by permanently fastening or joining the axial lamination stacks 24. Rotating the individual, adjacent axial lamination stacks 24 creates the skew pattern 18.

The skew angle 20 used for each embodiment or configuration of the rotor 10 may be chosen based upon various design goals, including, but not limited to: reducing torque ripple and cogging torque; reducing audible noise from the electric machine 8; and other factors or goals recognizable to those having ordinary skill in the art. In some embodiments of the rotor 10, the skew angle 20 may be inversely related to N_{skew}, the number of skew steps 22, such that an increase in N_{skew} results in a smaller skew angle 20.

Each of the magnet stacks 12 defines one pole of the rotor 10. Those having ordinary skill in the art will recognize that each rotor pole includes magnetic North and magnetic South. Therefore, the number of rotor poles, P, equals the number of the plurality of magnet stacks 12.

The stator 30 further includes a plurality of stator slots 32 and stator teeth 34. The stator slots 32 are gaps or spaces through which conductive windings are wrapped or otherwise routed. The stator slots 32 are between the stator teeth 34. The number of stator slots 32 is equal to the number of stator teeth 34, and both numbers may be expressed as: Nₛ. The winding wires or coils of the stator 30 are not shown in FIG. 1.

Winding patterns of the stator 30 may include concentrated windings, distributed integral slot windings, fractional slot windings, or other winding patterns known to those having ordinary skill in the art. In concentrated winding patterns, the coil is wound in a concentrated manner on every stator tooth 34. In distributed winding patterns, the coil is wound across a plurality of stator teeth 34, through a plurality of stator slots 32. Distributed integral-slot winding patterns have a ratio of stator slots 32 to rotor poles times the number of phases is equal to a positive integer (e.g. Nₛ/(P*φ) equals a positive integer, where φ is the number of phases, Nₛ is the number of stator slots and P is the number of rotor poles). Furthermore, any of the winding patterns may use wire with a rectangular cross-section as the winding conductor and increase the slot fill in the stator slots 32. Slot fill may be expressed as a ratio of the area occupied by the conductors with respect to the cross-sectional area in the stator slot 32 between adjoining stator teeth 34.

Calculation of the skew angle 20 may be further refined into a formula, such that the skew angle 20 is substantially equal to 360 degrees divided by the number of skew steps 22 plus one, multiplied by the least common multiple (LCM) of the number of rotor poles P and the number of stator slots 32. This may be expressed mathematically as a skew angle formula:

$$skew\_angle = \frac{360}{( {N}_{skew} + 1 ) * M} \pm δ$$

Where: N_{skew} is the number of skew steps 22; M is the least common multiple of Nₛ (the number of stator slots 32) and P (the number of rotor poles); and δ is the variance factor. The variance factor, δ, may be up to approximately 20% of the skew angle, and accounts for manufacturing tolerances and errors and also accounts for design variations from the base equation.

Note that in the above formula, the skew angle 20 is in mechanical degrees, where rotation through a full circle equals 360 degrees. This is as opposed to electrical degrees, in which the distance between magnetic North and South is equal to 180 degrees. Least common multiple is the smallest positive integer that is a multiple of both the inputs of the function. Since it is a multiple, it can be divided by either of the inputs without a remainder. For example, the least common multiple of 3 and 2 is 6.

A first exemplary embodiment of the rotor 10 may be configured for an electric machine 8 having a concentrated winding stator 30. For example, and without limitation, the concentrated winding stator 30 may have twenty-four stator slots 32 (Nₛ=24), and the rotor 10 may have sixteen magnet stacks 12 (P=16). The number of skew steps 22 remains two (N_{skew}=2).

The least common multiple of this first example is, therefore, M=48. From the skew angle formula above, the skew angle 20 for this first exemplary embodiment is equal to 2.50 degrees for N_{skew}=2. With a variance factor of 20%—i.e. plus or minus 0.5 degrees—the skew angle may be in the range of 2.00 to 3.00 degrees.

A second exemplary embodiment of the rotor 10 may be configured for an electric machine 8 having a distributed integral-slot winding stator 30. For example, and without limitation, the distributed integral-slot winding stator 30 may have seventy-two stator slots 32 (Nₛ=72), and the rotor 10 may have twelve magnet stacks 12 (P=12). The number of stew steps 22 remains two (N_{skew}=2).

The least common multiple of this second example is, therefore, M=72. Note that for distributed integral-slot winding patterns, the least common multiple of Nₛ and P is equal to the number of stator slots 32 (e.g. M=Nₛ). From the skew angle formula above, the skew angle 20 for this second exemplary embodiment is equal to 1.67 degrees. With a variance factor of 20% (about 0.33 degrees), the skew angle may be in the range of 1.33 to 2.0 degrees.

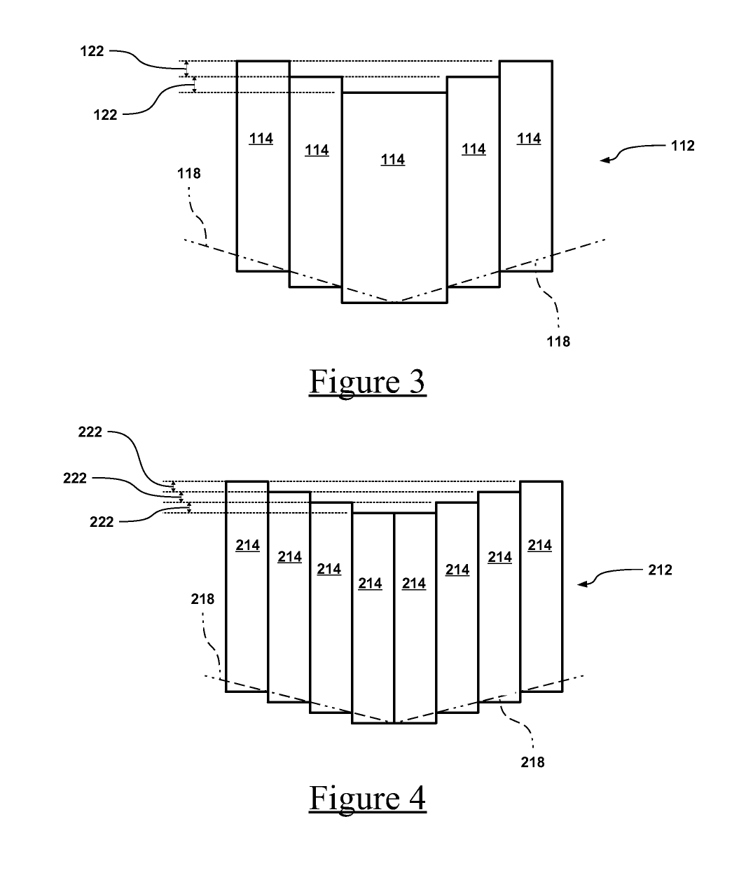

Referring now to FIG. 3, and with continued reference to FIGS. 1 and 2, there is shown a schematic top view of another configuration of a magnet stack 112 for a rotor (not shown in FIG. 3). In this view, the magnet stack 112 is shown laid flat, with linear spacing approximating the arc lengths if the magnet stack 112 were placed annularly on a rotor, similarly to the rotor 10 shown in FIGS. 1 and 2.

In the configuration shown in FIG. 3, the magnet stack 112 has five permanent magnets 114 arranged in a skew pattern 118. Although not shown, the five divisions may each be formed of two permanent magnets 114, similar to the pairs of magnets 14 shown in FIGS. 1 and 2. Note that in this configuration, one of the axial lamination stacks 24 (not shown) would be approximately twice the width of the other four, because the permanent magnet 114 located in the center of the magnet stack 112 is approximately twice the width of the other four.

The skew pattern 118 is an axially-symmetric V-shape, and still has two skew steps 122. Therefore, N_{skew} is again equal to 2. Calculation of the skew angle (not directly shown in FIG. 3, because the magnet stack 112 is laid flat) may use the same skew angle formula used for the skew pattern 18 shown in FIGS. 1 and 2. The magnet stack 112 could also be formed from as few as four permanent magnets 114, although such a configuration would likely include only one skew step 122.

The skew angle of the skew pattern 118 may be found from the skew angle formula above. This skew pattern 118 may be incorporated into a rotor configured to operate with a concentrated winding stator. For example, and without limitation, the concentrated winding stator may again have twenty-four stator slots (Nₛ=24), and the rotor may have sixteen magnet stacks (P=16). As shown in FIG. 3, the number of skew steps 122 is two (N_{skew}=2).

The least common multiple of this example is, therefore, M=48. From the skew angle formula above, the skew angle for skew pattern 118—configured for operation with a concentrated winding stator—is equal to 2.50 degrees. With a variance factor of 20% (0.5 degrees), the skew angle may be in the range of 2.00 to 3.00 degrees.

Referring now to FIG. 4, and with continued reference to FIGS. 1-3, there is shown a schematic top view of another configuration of a magnet stack 212 for a rotor (not shown in FIG. 4). Similar to FIG. 3, the magnet stack 212 is also shown laid flat, with linear spacing approximating the arc lengths if the magnet stack 212 were placed annularly on a rotor, such as the rotor 10 shown in FIGS. 1 and 2.

In the configuration shown in FIG. 4, the magnet stack 212 has at least eight permanent magnets 214 arranged in a skew pattern 218. Although not shown, the eight divisions may each be formed of two permanent magnets 214, similar to the pairs of permanent magnets 14 shown in FIGS. 1 and 2, such that a total of sixteen magnets would be used in the magnet stack 212. Additionally, the two center magnets could be replaced with a single, double-width magnet, similar to the configuration shown in FIG. 3, such that either seven or fourteen magnets would be used in the magnet stack 212.

The skew pattern 218 is again an axially-symmetric V-shape. However, skew pattern 218 has three skew steps 222, therefore, N_{skew} is equal to 3. The additional skew steps 222 will decrease the calculated skew angle between permanent magnets 214 adjacent to the skew steps 222. Calculation of the skew angle (not directly shown in FIG. 4, because the magnet stack 212 is laid flat) may use the same skew angle formula used for the skew pattern 18 shown in FIGS. 1 and 2, and for the skew pattern 118 shown in FIG. 3. As viewed in FIGS. 3 and 4, the relationship between skew angle and skew steps 122, 222 shows that a larger skew angle yields a larger skew step 122, 222.

The skew angle of the skew pattern 218 may be found from the skew angle formula above. This skew pattern 218 may also be incorporated into a rotor configured to operate with a concentrated winding stator. For example, and without limitation, the concentrated winding stator may again have twenty-four stator slots (Nₛ=24), and the rotor may have sixteen magnet stacks (P=16). As shown in FIG. 4, the number of skew steps 222 is three (N_{skew}=3).

The least common multiple of this example is, therefore, M=48. From the skew angle formula above, the skew angle for skew pattern 218—configured for operation with a concentrated winding stator—is equal to 1.875 degrees. With a variance factor of 20% (which equates to approximately plus or minus 0.375 degrees), the skew angle may be in the range of 1.50 to 2.25 degrees. Therefore, the skew steps 222 shown in FIG. 4 are somewhat smaller than the skew steps 122 shown in FIG. 3 (although the schematic figures may not be drawn to exact scale).

While the best modes and other modes for carrying out the claimed invention have been described in detail, those familiar with the art to which this invention relates will recognize various alternative designs and embodiments for practicing the invention within the scope of the appended claims.

1. A rotor for an electric machine, comprising:
a plurality of magnet stacks, each having at least five permanent magnets therein, wherein said plurality of magnet stacks are arranged annularly about a rotor axis; and
a skew pattern formed by said at least five permanent magnets within each of said plurality of magnet stacks, wherein said skew pattern is defined by:
a skew angle; and
at least two skew steps, wherein said skew angle is an angle of rotation about said rotor axis between individual permanent magnets adjacent to each of said at least two skew steps.

2. The rotor of claim 1, wherein said skew pattern is symmetric along said rotor axis.

3. The rotor of claim 2, wherein said skew pattern is an axially-symmetric V-shape.

4. The rotor of claim 3, wherein said skew angle is inversely related to the number of said at least two skew steps.

5. The rotor of claim 4, wherein the number of said at least two skew steps is equal to two skew steps.

6. The rotor of claim 5, wherein each of said plurality of magnet stacks has at least five permanent magnets.

7. The rotor of claim 5, wherein each of said plurality of magnet stacks has at least six permanent magnets.

8. The rotor of claim 3, wherein the number of said at least two skew steps is equal to three skew steps.

9. The rotor of claim 8, wherein each of said plurality of magnet stacks has eight permanent magnets.

10. The rotor of claim 3,
wherein each of said plurality of magnet stacks defines one pole of the rotor, such that the number of rotor poles equals the number of said plurality of magnet stacks;
wherein the rotor is configured to operate in conjunction with a stator having a plurality of stator slots; and
wherein said skew angle is substantially equal to 360 degrees divided by the number of said at least two skew steps plus one, multiplied by the least common multiple of the number of rotor poles and the number of said plurality of stator slots.

11. A magnet stack of an electric machine including a stator with a number of stator slots and a rotor configured to rotate about an axis and having a number of rotor poles, each magnet stack comprising:
a number of permanent magnets arranged in a non-linear skew pattern, wherein said non-linear skew pattern is defined by:
a number of skew steps; and
a skew angle defining the rotation about the axis between permanent magnets adjacent each of said skew steps.

12. The magnet stack of claim 11, wherein said skew angle is defined, in mechanical degrees, by the formula:
$$skew\_angle = \frac{360}{( {N}_{skew} + 1 ) * M} \pm δ ;$$
wherein N_{skew} is the number of skew steps;
wherein M is the least common multiple of the number of stator slots and the number of rotor poles; and
wherein δ is a variance factor.

13. The magnet stack of claim 12, wherein said number of skew steps is at least 2.

14. The magnet stack of claim 13, wherein said non-linear skew pattern is a V-shape and is symmetric along the axis of the rotor.

15. The magnet stack of claim 14, wherein said number of permanent magnets is at least six.

16. The magnet stack of claim 14, wherein said variance factor is within a range of 0 to 20% of the value of said skew angle.

17. The magnet stack of claim 14, further comprising a number of axial lamination stacks, wherein each of said number of axial lamination stacks is configured to support one of said number of permanent magnets, such that said number of axial lamination stacks is equal to said number of permanent magnets.

18. A magnet stack of an electric machine including a stator with a number of stator slots and a rotor configured to rotate about an axis and having a plurality of the magnet stacks disposed annularly thereon, each magnet stack comprising:
at least five permanent magnets arranged in a non-linear skew pattern with at least five magnet divisions, wherein said non-linear skew pattern is a V-shape and is symmetric along the axis of the rotor.

19. The magnet stack of claim 18, wherein said non-linear skew pattern further includes:
at least two skew steps; and
a skew angle defining the rotation about the axis between permanent magnets adjacent said at least two skew steps.
